(19) United States
(12) Patent Application Publication
(10) Pub. No.: US 2014/0363602 A1
(43) Pub. Date: Dec. 11, 2014

(54) Conveniently reusable photopaper and advertising film

(71) Applicants: Yu Xiaoguang, Town Dongguan (CN); Yang Fang, Town Dongguan City (CN); Wang Zhongzheng, Town Dongguan City (CN); Li Yuanke, Town Dongguan City (CN)

(72) Inventors: Yu Xiaoguang, Town Dongguan (CN); Yang Fang, Town Dongguan City (CN); Wang Zhongzheng, Town Dongguan City (CN); Li Yuanke, Town Dongguan City (CN)

(21) Appl. No.: 14/005,274

(22) PCT Filed: May 29, 2012
(86) PCT No.: PCT/CN12/76221

§ 371 Date: Sep. 16, 2013

(30) Foreign Application Priority Data
Jan. 11, 2012 (CN) 20120008797.6

(51) Int. Cl. C09J 7/04; C09J 7/02

(52) U.S. Cl. CPC C09J 7/041; C09J 7/0275; C09J 7/0278; C09J 7/0285; C09J 2467/006; C09J 2427/006; C09J 2423/166; C09J 2400/283; C09J 2433/00; C09J 2475/00
USPC 428/40.7; 428/41.8; 428/41.5; 428/41.3

(57) ABSTRACT

A photographic paper and advertizing film poster convenient for re-adhering relates to a photographic paper and an advertizing film. The photographic paper and advertizing film poster comprises a main body and an adhesive coating. The main body is a photographic paper or an advertizing film. The adhesive coating is disposed on the back of the main body. The adhesive coating is a high-molecular polymer coating having features of elastic flexible adhesive. The adhesive coating is also adhered with a separable material layer. The photographic paper is a piece of RC photographic paper, cast coated photographic paper laminated with a film on the back or swellable photographic paper. The advertizing film is a PP film, PVC film, PET film or compound film with a blotting coating. The problem that convenient, long-term and repeated adhesion photographic paper and advertizing film poster cannot be realized at the same time on the wall with emulsion paint, glass, stainless steel and wood plate is solved. Stable adhesion and a vacuum absorption are generated between the adhesive coating and the surface of the adhered object, so the product realizes long-term adhesion on condition of low adhesion.

### BACKGROUND OF THE INVENTION

1. Technical Field

The invention relates to a photographic paper and advertizing film poster, in particular to a photographic paper and advertizing film poster convenient for re-adhering. The so called “re-adhered” refers to that the photographic paper and advertizing film poster can be conveniently removed and adhered at another position after being adhered at a position, requiring that the photographic paper and advertizing film poster is intact while the adhered positions such as a wall surface, plate surface or page are not damaged.

2. Description of Related Art

Photographic papers and advertizing films with adhesive on the back are a kind of products applied to more and more fields in the daily life. However, this kind of products has many defects in use at present. The adhesion increases as the time goes by and finally causes difficulties in peeling of the products. The products are easily damaged when peeled. The adhered base materials may generate glue residue, in particular, convenient, long-term and repeated adhesion on the wall with emulsion paint cannot be removed at the same time. The above defects affect the application scope of the products and increase the labor intensity and material cost during replacement.

Meanwhile, a China patent “Plastic Wall Poster Causing No Harm to Walls” (Filling No.: 201020185533.9, authorized publication No.: CN201857362U) has been disclosed. The plastic wall poster is similar to a double-sided tape located on the backs of objects such as spring festival drawings, sticky notes such that those objects can be adhered to walls or wardrobe surfaces. This patent solves the problems of unstable adhesion, disposable use or damage to wall surfaces, etc. caused by the adhesive layers of the traditional plastic wall posters usually made of white adhesive, yellow adhesive, double sided tape, etc. It puts forward a technical scheme of adhering an adhesive layer to the bottom of the plastic layer, wherein the adhesive layer is an elastic, flexible, thin adhesive layer undergoing additive polarity treatment, and the elastic, flexible, thin adhesive layer is a styrene segmented copolymer coating. The plastic wall poster can be used for several times and cause no harm to the wall surface, etc., but needs two layers of adhesive, so the manufacturing process is complicated.

### BRIEF SUMMARY OF THE INVENTION

### Technical Contents

The invention aims to overcome the above-mentioned defects in the prior art and provide a photographic paper and advertizing film poster convenient for re-adhering. The photographic paper and advertizing film poster can be adhered to the smooth and dense surfaces of the wall with emulsion patent, glass, stainless steel or wood for a long time, features in reusability and convenient dislocation and removal, causes no harm to the product itself or the adhered base material, and does not leave adhesive residue.

### SCHEME FOR SOLVING PROBLEMS

### Technical Scheme

The invention provides a photographic paper and advertizing film poster convenient for re-adhering. The invention adopts the following technical scheme.

A photographic paper and advertizing film poster convenient for re-adhering is provided, comprising a main body. The main body is a piece of photographic paper or an advertizing film. The invention is characterized by also comprising an adhesive coating and a separable material layer. The adhesive coating is coated on the back of the main body. The separable material layer is adhered to the adhesive coating. The adhesive coating is a high-molecular polymer coating having features of elastic flexible adhesive.

The above technical scheme is further described below:

The adhesive coating is polyurethane, polyacrylic ester or organic silicon resin. The photographic paper is a piece of RC photographic paper, cast coated photographic paper laminated with a film on the back or swellable photographic paper.

The advertizing film is a PP film, PVC film, PET film or compound film with a blotting coating.

The separable material layer is silicon coated fluoride separable film or silicon coated separable paper.

The invention adopts the principle of vacuum absorption and adhesion. The specific adhering and jointing mechanism is as follows: the adhesive coating features in low adhesion , low surface tension, and low bonding strength, high elasticity and high cohesion. During adhering, the adhesive coating is quickly adhered to the smooth and dense surfaces of the bonded objects (such as a wall with emulsion paint, glass, stainless steel and wood plate), so the adhesion of the main body gradually reaches the maximum value on the adhered surface and easily forms a closed sub atmospheric pressure contact surface. Meanwhile the surface of the bonded object generates a force enough to absorb the photographic paper or advertizing film as the main body through the closed sub atmospheric pressure contact surface. Therefore, the main body and the surface of the bonded object are tightly adhered to each other by the common action of the absorption force big enough and the low bonding force. This kind of adhesion mainly depends on action of the absorption force of the sub atmospheric pressure contact surface formed by the adhesive coating and the surface of the bonded object instead of the bonding force and therefore does not fall off. Meanwhile, the invention features in reusability, convenient re-use, causes no harm to the film and the bonded object when removed, and does not leave adhesive reminders.

### THE INVENTION HAS THE FOLLOWING BENEFICIAL EFFECTS

### Beneficial Effects

Compared with the prior art, the invention has the following beneficial effects: 1. The problem that convenient, long-term and repeated adhesion photographic paper and advertizing film poster cannot be realized at the same time on the wall with emulsion paint, glass, stainless steel and wood plate is solved. Stable adhesion and a vacuum absorption are generated between the adhesive coating and the surface of the adhered object, so the product realizes long-term adhesion on condition of low adhesion. 2. The invention features in reusability, convenient re-use, causes no harm to the film and the bonded object when removed, and does not leave adhesive reminders. 3. The invention has high weather fastness, and the adhesion and elasticity of the adhesive coating are kept stable as the time or environment changes, thus realizing long-term adhesion on the smooth and dense surfaces of the wall with emulsion paint, glass, good plate, etc. 4. The invention widens the application scope of the photographic paper or advertizing film with glue on the back and reduces the labor intensity and material cost during replacement.

### BRIEF DESCRIPTION OF THE SEVERAL VIEWS OF THE DRAWINGS

### Attached Drawings of the Description

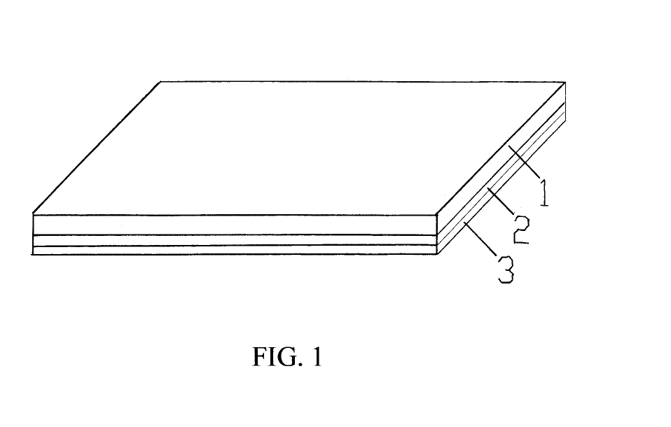

FIG. 1 is a schematic view of the invention. In the figure, 1-main body, 2-adhesive coating, 3-separable material layer.

### EMBODIMENTS OF THE INVENTION

### Mode of Execution of the Invention

The specific mode of execution of the invention is described in detail with reference to the attached drawings.

As shown in FIG. 1, a photographic paper and advertizing film poster convenient for re-adhering comprises a main body 1. The main body 1 is a piece of photographic paper or an advertizing film. The invention is characterized by also comprising an adhesive coating 2 and a separable material layer 3. The adhesive coating 2 is coated on the back of the main body 1. The separable material layer 3 is adhered to the adhesive coating 2. The adhesive coating 2 is a high-molecular polymer coating having features of elastic flexible glue. Of course, the front face of the main body 1 is the image face of a piece of photographic paper or the calligraphy and painting face of the advertising film.

The adhesive coating 2 conducts the protection function. For adhering, the separable material layer 3 is torn.

The adhesive coating 2 is a high-molecular polymer such as polyurethane, polyacrylic ester or organic silicon resin, or mixtures of at least two of them.

The photographic paper is a piece of RC photographic paper, cast coated photographic paper laminated with a film on the back or swellable photographic paper.

The advertizing film is a PP film, PVC film, PET film or compound film with a blotting coating.

The separable material layer is a silicon coated fluoride separable film or silicon coated separable paper.

Specifically in use, tear away the separable material layer 3, adhere the photographic paper or advertizing film as the main body 1 to the surface of the bonded object such as a wall with emulsion paint, glass, stainless steel or wood plate, and then slightly press it. To change the position, slightly take off the photographic paper or advertizing film from the edge, and adhere it to another new position. The adhesion and taking off are very conveniently.

The above embodiment does not limit the technical scope of the invention. Those skilled in the art can made some changes and modifications under the enlightenment of the technical scheme. Within the technical spirit and principle of the invention, any modification, equivalent substitution and improvement of the above embodiment all shall be corporate in the protection scope of the invention.

### INDUSTRIAL APPLICABILITY

The invention provides a photographic paper and advertizing film poster convenient for re-adhering. The invention solves the problem that convenient, long-term and repeated adhesion photographic paper and advertizing film poster cannot be realized at the same time on walls with emulsion paint, glass, stainless steel and wood plate. It features high re-usability and weather fastness, widens the application scope of the photographic paper or advertizing film with adhesive on the back, reduces the labor intensity and material cost during replacement. It therefore has industrial applicability.

What is claimed is:

1. A photographic paper and advertizing film poster convenient for re-adhering comprising a main body which is a piece of photographic paper or an advertizing film, characterized by also comprising an adhesive coating and a separable material layer; the adhesive coating being coated on the back of the main body, the separable material layer being adhered to the adhesive coating, the adhesive coating being a high-molecular polymer coating having features of elastic flexible adhesive.

2. The photographic paper and advertizing film poster convenient for re-adhering according to claim 1, characterized in that the adhesive coating is polyurethane, polyacrylic ester or organic silicon resin.

3. The photographic paper and advertizing film poster convenient for re-adhering according to claim 1, characterized in that the photographic paper is a piece of RC photographic paper, cast coated photographic paper laminated with a film on the back or swellable photographic paper.

4. The photographic paper and advertizing film poster convenient for re-adhering according to claim 1, characterized in that the advertizing film is a PP film, PVC film, PET film or compound film with a blotting coating.

5. The photographic paper and advertizing film poster convenient for re-adhering according to claim 1, characterized in that the separable material layer is silicon coated fluoride separable film or silicon coated separable paper.
